(19) United States
(12) Patent Application Publication
(10) Pub. No.: US 2009/0121836 A1
(43) Pub. Date: May 14, 2009

(54) Systems and Methods for Determining Identity and Personal Assistance

(75) Inventors: Jeffrey Mikan, Atlanta, GA (US); Kenneth D. Heil, Marietta, GA (US); Justin McNamara, Atlanta, GA (US); Fulvio Arturo Cenciarelli, Suwanee, GA (US); John Lewis, Lawrenceville, GA (US)

Correspondence Address: AT&T Legal Department - Moazzam;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 11/937,354

(22) Filed: Nov. 8, 2007

(51) Int. Cl. H04Q 5/22

(52) U.S. Cl. 340/10.1

(57) ABSTRACT

Systems and methods are disclosed which relate to identification and reminding. A wireless communication device is mounted at a point of security such as a car. When a user wishes to enter or start the car, the wireless communication device detects nearby items through wireless communication. These items, which possess wireless transmitters, are compared with an internal database to determine the identity of the user. Once the identity has been determined, the user can then be reminded of missing items.

### BACKGROUND OF THE INVENTION

1. Field of the Invention

The present invention relates to identification and assistance. More specifically the present invention relates to identification primarily for the purposes of unlocking and entering a vehicle and assistance primarily in reminding a user of forgotten items.

2. Background of the Invention

In today's ever-more demanding lifestyles, acts which were once simple and routine are becoming increasingly demanding. For example, one such act is getting into and starting a vehicle, and traveling somewhere without forgetting all that is needed to be brought on the travel. Some people forget or misplace keys while others find themselves carrying so much that the simple process of inserting a key and turning becomes a little more enduring. Other people have even found themselves locked out of their car while it is running, a frustrating situation no one wants to be in.

Unlocking and starting a vehicle is a very routine process for many people. Driving also requires more than just keys. In the United States, drivers must carry a driver's license and either vehicle registration or proof of insurance. Most drivers don't think of it this way though. Most drivers need their wallet, purse, phone, watch, personal data assistant (PDA), etc. These items may not let one into or start a car, but they are just as easy to leave behind for the same reason.

Recent advances designed to address the problems in this area include technology such as remote keyless entry or password type keyless entry. Keyless entry usually only means unlocking the vehicle. This has been taken to the next level with remote start vehicles, which can actually turn the engine on from a remote location. However, all of these methods still require some sort of physical device combined with an action in order to accomplish the task. Also, the remote technologies all use some sort of wireless code, like a radio frequency (RF), which can be unlocked by an unauthorized user.

In the meantime wireless technology continues to grow. What has begun with simple radio frequencies has spawned into WI-FI and BLUETOOTH, which are each capable of high security encryption. BLUETOOTH has been featured in many small electronic devices including cellular telephones and accessories, Global Positioning System (GPS) units, PDA's, etc. Radio frequency identification (RFID) is not quite as secure as WI-FI or BLUETOOTH, but each RFID tag is unique and detectable up to about twenty feet. The general advantage of RFID does not lie in its security, but the actual RFID tag is very small and can be less than paper thin. Some recent developments in RFID technology have even led to a tattoo-like tag, which is merely printed on the surface of an item making it very thin and unnoticeable.

What is needed in the art is a method of entering a vehicle that is more convenient than current methods and without the need for any one single item. Also, a method of making sure a driver has all the necessary equipment he or she needs before driving is needed. This method should make use of all the new advances in wireless technology including WI-FI, BLUETOOTH, and RFID.

### SUMMARY OF THE INVENTION

The present invention includes wireless communication among multiple items as a method of determining identity and a method of reminding a user of missing items. Unlocking a vehicle will no longer be a problem because using various embodiments of this invention a vehicle can detect a user as the user approaches the vehicle. The user's identity is detected by the personal items the user is carrying such as a watch, cellular telephone, PDA, laptop computer, etc. While no single item can get the job done, as a security measure, the combination of all the items lets the vehicle know that its owner is near. Once the identity has been determined the vehicle unlocks, starts, even open its driver side door or trunk for the user. Not only does this greatly benefit the user, but the vehicle can then take another step and remind the user of essential items the vehicle did not find, even for a given date. Items such as golf clubs on Sundays, or a granola bar on weekdays can be programmed by the user so the user does not forget them when such items should accompany the user.

Furthermore, the present invention is not limited to vehicles, but can be used at any point of security or other place where a user may find it beneficial to have a reminder of forgotten items. A user may even have one in a vehicle which also controls the user's house, office, computer database, etc. Because the number of items necessary for identification has no limit, it has application in military, correctional, and other top security functions as well.

In one exemplary embodiment, the present invention is an identification system which comprises a wireless communication device and a plurality of items possessing unique wireless identifiers. Unique wireless identifiers are already present in many electronic devices such as PDA's, laptops, cellular telephones, etc. which commonly possess BLUETOOTH or WI-FI technology. Those items which do not already possess unique wireless identifiers can have them added using the latest in RFID technology, which takes the form of a “tattoo” which can literally be printed on the surface of an item. This gives the user a vast selection of personal belongings to require for identification, making it very hard for a potential imposter to have any idea which items the potential imposter needs to fake the user's identification.

In another exemplary embodiment, the present invention is a reminder system designed to assist a user when the user has forgotten a necessary or desired item. This is a great solution for those mornings when a user is running late and does not have time to make sure he or she has everything needed for that particular day. Once the user reaches the car a wireless communication device issues an aural or visual reminder of the items the user is missing. The user programs the wireless communication device with a plurality of setup forms which are stored in a database. Users are encouraged to create many setup forms to be reminded of many things such as a laptop every weekday, or reading glasses before going to the office.

### BRIEF DESCRIPTION OF THE DRAWINGS

FIG. 1 shows a system for determining identity according to an exemplary embodiment of the present invention.

FIG. 2 shows a screen shot of a software program used to setup identification according to an exemplary embodiment of the present invention.

FIG. 3 shows a flow chart for a process of determining identity according to an exemplary embodiment of the present invention.

FIG. 4 shows a system for reminding a user of missing items according to an exemplary embodiment of the present invention.

FIGS. 5A-D show screen shots of a software program used to personalize a reminder system according to an exemplary embodiment of the present invention.

FIG. 6 shows a flow chart for a process of reminding a user of missing items according to an exemplary embodiment of the present invention.

### DETAILED DESCRIPTION OF THE INVENTION

The present invention includes wireless communication among multiple items as a technique for determining identity and a method of reminding a user of missing items. The user preprograms a wireless communication device to detect his or her items as the user gains access to a vehicle, house, locker, office, safe, encrypted data files, or other point of security. These items all have unique wireless identifiers. Once a minimum number of the user's items have been detected the wireless communication device allows entry or operation. If any of the user's required items are missing, the wireless detection device reminds the user of the missing items. The wireless communication device uses a broad range of wireless communication methods including, but not limited to, BLUETOOTH, WI-FI, and RFID, and combinations thereof.

As used in this disclosure, “wireless communication” refers to any wireless transmission or detection. “Wireless communication” includes both one-way and two-way communication. The term “item” and its variations are used throughout this disclosure to describe a vast majority of tangible belongings. Though it is not a technical term it is meant to encompass any and all possible physical belongings that a user may have either to determine the user's identity, or simply wish to be reminded when it is missing. Wireless transmitters get smaller as technology evolves, and since RFID transmitters can now be less than paper thin, the term “item” potentially describes any physical object. Examples to outline the breadth of this term include, but are not limited to, clothing, equipment, collectables, disposables, consumables, etc. Even pets are candidates for unique wireless identifiers. “Point of security”, as used in this disclosure, refers to any secure enclosure or encrypted data such as of the type requiring a key, combination, password, or any other method of limiting access to certain individuals. “Points of security” include homes, vehicles, lockers, safes, data files, and even prisons.

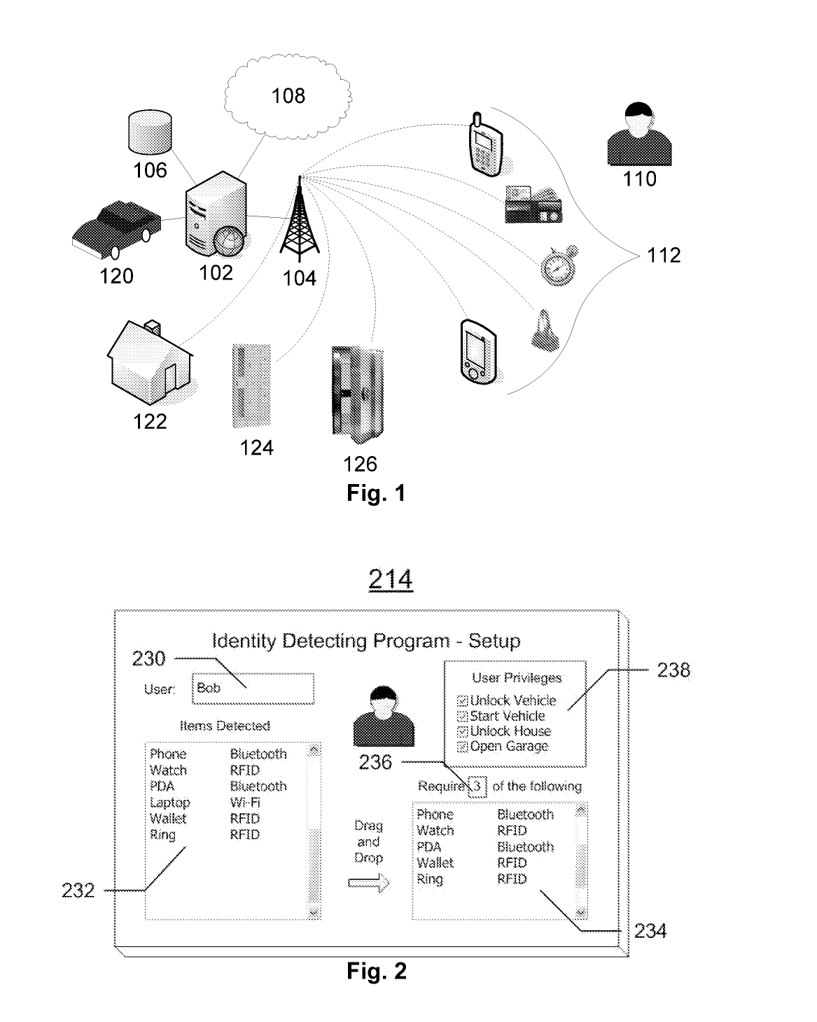

In one exemplary embodiment, shown in FIG. 1, the present invention is a system of secure keyless entry. This embodiment features a system for identification based on a wireless communication device capable of detecting multiple items through wireless communication, then comparing the items with a database to determine the user's identity. The wireless communication device can be incorporated into a vehicle, house, locker, or any other point of security. The wireless communication device can even control remote points of security through wireless communication.

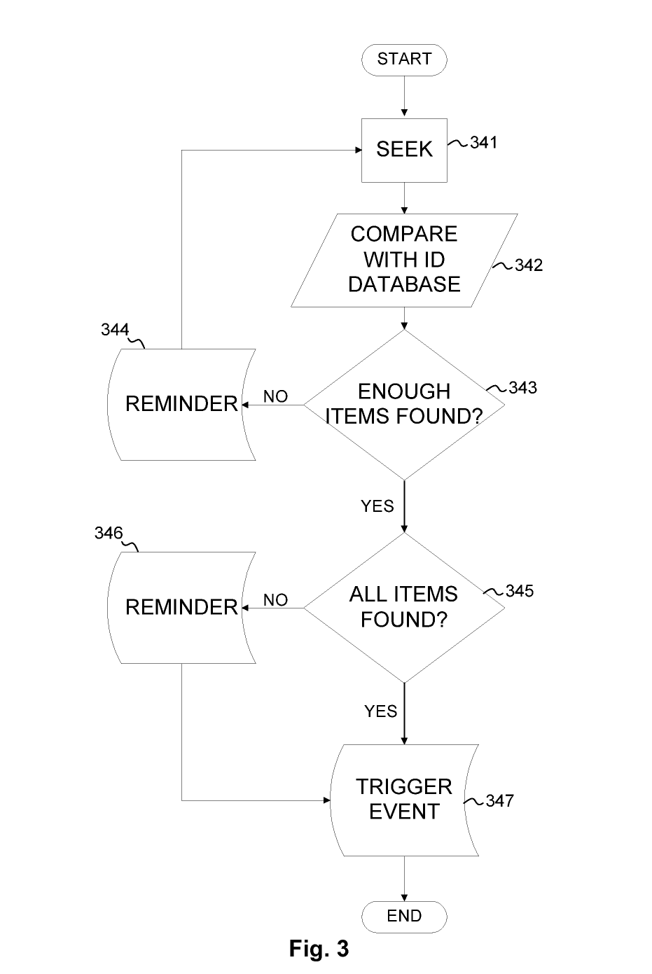

FIG. 1 shows a wireless communication device 102 that is incorporated into a vehicle 120. Wireless communication device 102 also communicates wirelessly to a plurality of items 112 and other points of security including a house 122, a locker 124, and a safe 126. Wireless communication device 102 works with an antenna 104 to communicate using BLUETOOTH, WI-FI, RFID, or any other wireless communication protocol in the art. A setup form 214 is shown in FIG. 2, where user 110 enters the items to be identified. The user's name is entered in box 230. Box 232 shows a list of currently detected items that are within a detectable range of wireless communication device 102. This range will vary with the wireless protocol used. For instance, an item with an RFID tag needs to be within about twenty feet, but an item with a WI-FI transmitter can be detected from much farther away. From the list of currently detected items, user 110 can drag and drop to box 234 any items that the user feels is necessary to establish the user's identity. User 110 may not wish to be forced to carry all of the items in box 234 to gain entry, so the user may specify a minimum amount of items the user feels are necessary to establish identity. For example, user 110 usually has a wallet, watch, cellular telephone, PDA, and a camera. If user 110 is running late, and has forgotten the camera but has the other four items, user 110 will not want to be forced to find the camera in order to unlock the car. Once identity is established, user 110 is entitled to the privileges selected from box 238, such as unlocking and starting vehicle 120. Since wireless communication device 102 can communicate with house 122, user 110 may also choose to unlock the house or open the garage door from the privileges in box 238.

Alternatively, the user 110 can set up the system to ensure that a specific portion of a vehicle 120 (house 122 or other) opens whenever a specific tag or series of tags is recognized. For example, whenever a briefcase, laptop bag or large box is recognized by the system, the trunk of the vehicle 120 may be programmed to open automatically to ensure ease of placement of the recognized item into the trunk.

In another exemplary embodiment, the system may be set up to recognize RFID tags when the user 110 is leaving the vehicle 120 and alert the user 120 whenever an item has been left behind that should not be. For example, a briefcase or cellular telephone may have been inadvertently left behind, and the user 110 may be alerted to this before the user 110 is too far from the vehicle 120. Other examples include but are not limited to briefcases, food, pets, food, gifts, etc. The present system can prevent the dreaded forgotten leftover food that is inadvertently left in a vehicle overnight.

Setup form 214 is one of many user 110 can specify. User 110 is encouraged to complete many setup forms for each user, and even multiple setup forms per user. For instance, user 110 may have a wallet, watch, cellular telephone, PDA, and a camera on weekdays, but on the weekend user 110 doesn't carry all of those items. Instead user 110 has a wallet and watch, is wearing sandals and a baseball cap, and carries a cigar cutter. User 110 may complete another setup form for the weekend. User 110 may even set up a particular list of items needed for a particular trip, either a vacation or a business meeting. The system could even be set up to run a particular profile depending on the detection of a particular tagged item, such as the running of the beach/weekend profile upon detection of a flip-flops. The possibilities are endless. The setup forms are not necessarily exclusive to specific days however; the user may gain entry by carrying the required items for either setup form at any time. Once user 110 has completed setup form 214, it is stored in database 106 with all the other complete setup forms. User 110 can complete setup forms for each other user, while specifying different items and privileges for each other user.

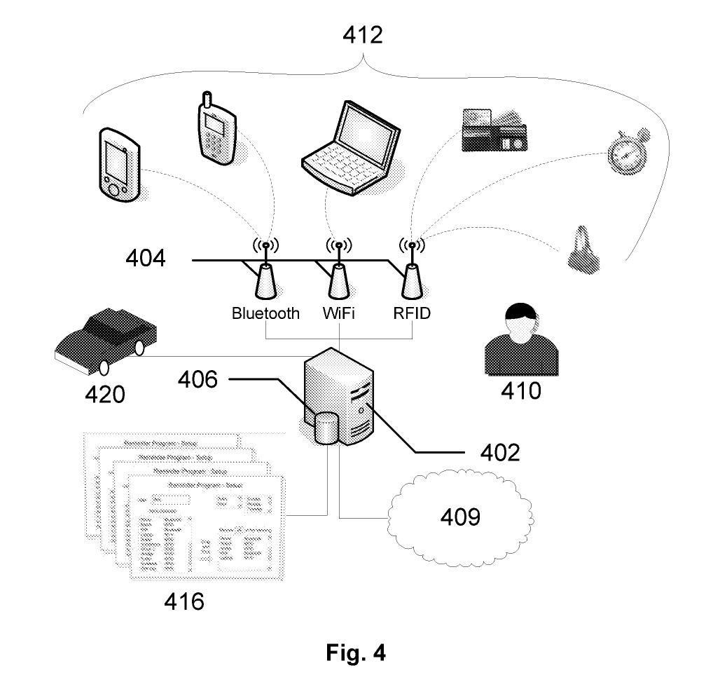

A flow chart for an identification process 108 performed by wireless communication device 102 is shown in FIG. 3. First, wireless communication device 102 seeks 341 all the items within range. The seeking action can be initiated by the press of a button or some other pre-designated event. Such event can, include, for example, a user walking up to a vehicle, or entering a vehicle. Other such trigger events are also possible and within the scope of the present invention. Next, wireless communication device 102 checks 342 database 106 for a setup form that matches the criteria for detected items. When wireless communication finds a setup form that matches the found items, it checks 343 to see if enough items are present to determine an identity based on the criteria in boxes 234 and 236 of a setup form. If there are not enough items present to determine identity, wireless communication device 102 issues a reminder 344. This reminder can be aural, visual, or both. Once the user has gathered all necessary items the user can send wireless communication device 102 back into “seek” mode 341. The detected items match a setup form 342 and wireless communication device 102 then checks to see if enough items are detected 343 to establish identity. If enough items are detected the wireless communication device then allows all of the privileges in box 238. Wireless communication device 102 then checks to see if all the items are present 345. If less than all of the items are present wireless communication device 102 will still issue a reminder 346 just before activating the privileges. Alternatively, wireless communication device 102 can constantly search for items, and allow privileges as soon as it finds a match. In this manner, user 110 can trigger an event 347, such as simply walk toward vehicle 120 while wireless communication device 102 auto detects user 110's items and has already unlocked and started the car by the time user 110 reaches vehicle 120. This includes a process requiring no action at all by user 110 provided user 110 is in possession of all necessary items.

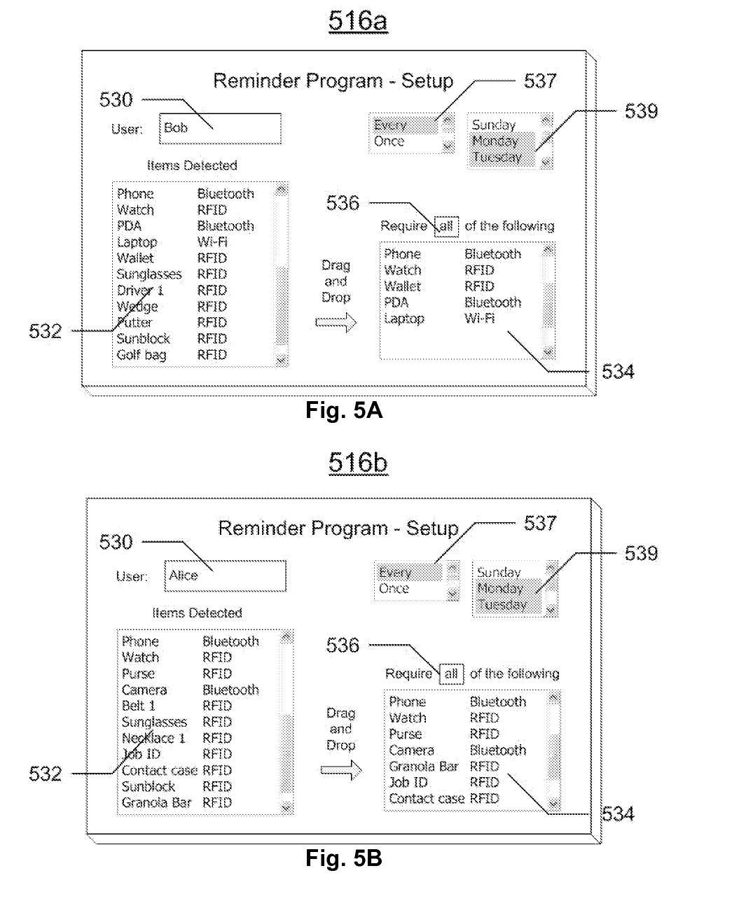

In another exemplary embodiment, shown in FIG. 4, the present invention is a system for reminding a user of missing items. In this embodiment the wireless communication device detects multiple items through wireless detection, and then compares the items found with a database to determine which items, if any, are missing.

The system includes a wireless communication device 402, which works together with an antenna 404, a database 406, and a reminding process 409. A user 410 completes at least one setup form 416 where user 410 can specify items the user will need or want upon a specified trigger event. The specified event can be every morning when the car 420 is unlocked, every Sunday morning when the car is started, one time next Tuesday when the car is unlocked, or even any time at the press of a button simply for the user's peace of mind. Upon the specified event, wireless communication device 402 attempts to detect a single or plurality of items 412 through wireless communication. This list is pulled from the appropriate form 416. If less than the single or plurality of items 412 are detected, wireless communication device issues a reminder. This reminder can be a human voice specifying which from the single or plurality of items 412 are missing, a visual alert and a picture of the item(s), or both.

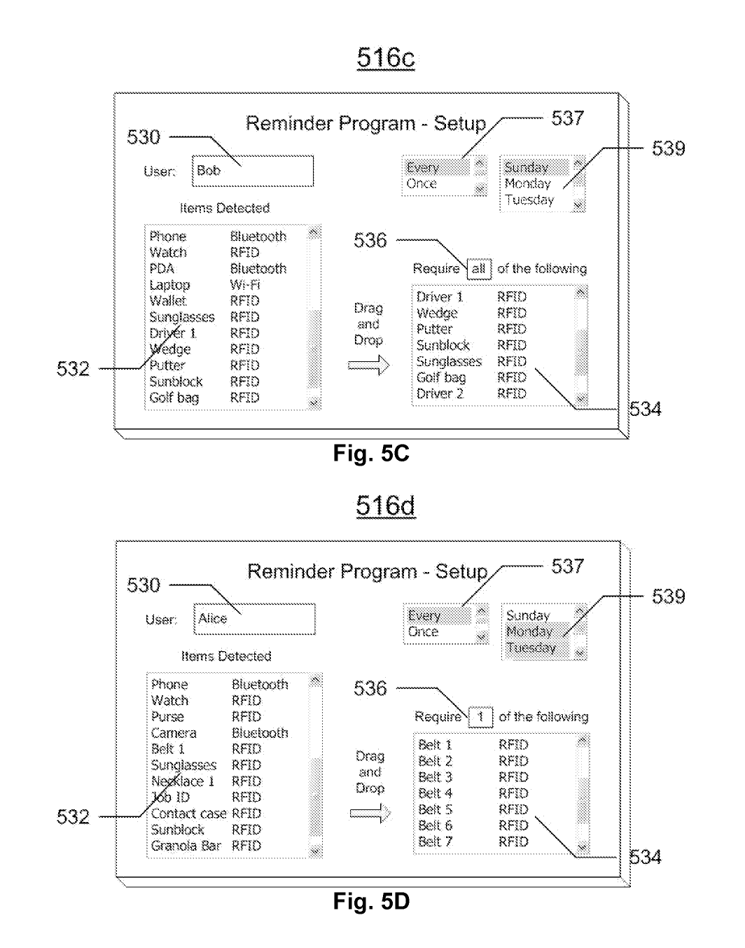

Sample setup forms 516A-D are shown in FIGS. 5A-D, where user 410 enters the items of which to be reminded. The user's name is entered in box 530. Box 532 shows a list of currently detected items that are within a detectable range of wireless communication device 402. This range will vary with the wireless protocol used. For instance, an item with an RFID tag needs to be within about twenty feet, but an item with a WI-FI transmitter can be detected from and up to approximately 0.3-1.0 miles away. From the list of currently detected items, user 410 can drag and drop to box 534 the items of which user 410 would like to be reminded. An event is to be specified in boxes 537 and 539. This is the event upon which wireless communication device 402 performs the reminding process 409. Box 537 allows user 410 to select a frequency of the reminder, such as “every”, “next”, “every other”, etc., while box 539 allows user 410 to select a time, act, or any other event upon which wireless communication device 402 is capable of acting, such as “Sunday”, “July 4^{th}”, “Weekday”, “Press of a button”, “Vehicle Ignition”, etc. The combination of boxes 537 and 539 create a phrase such as “Every Wednesday”, “Next July 4^{th}”, “Every other Vehicle Ignition”, etc. Once user 410 has completed setup form 416, it is stored in database 406. User 410 can complete a setup form for each instance of reminder user 410 desires. User 410 is encouraged to create many reminders for any and all events the user may desire a reminder. User 410 may also create reminders for each other user while specifying different items to be reminded of at specified events for the other users.

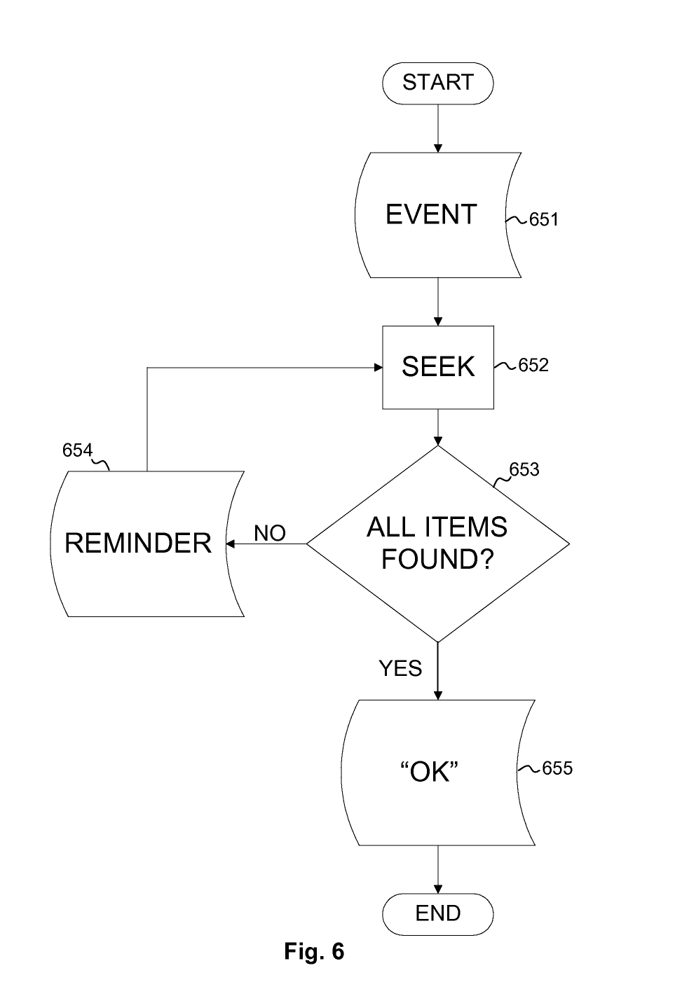

A flow chart for a reminding process 409 performed by wireless communication device 402 is shown in FIG. 6. First, an event 651 from a setup form triggers wireless communication device 402 to detect 652 present items through wireless communication. Once the items have been detected, they are compared with the items in box 534 of the triggering setup form. If all of the items from box 534 have been detected 653, then wireless communication device 402 issues, for example, a visual or aural alert 655 to user 410 that all items have been found. If less than all of the items in box 534 are detected, then wireless communication device 402 issues a visual or aural warning 654 that user 410 does not have all the items that appear in box 534. For example, in FIG. 5A, user Bob has completed a setup form to ensure that he has his cellular telephone, watch, wallet, PDA, and laptop computer. Bob has specified that he needs to have this reminder every weekday. Only Monday and Tuesday can be seen, but the box is scrollable and the other selected days are hidden in this view. When Bob approaches his vehicle on weekdays wireless communication device 402 will seek Bob's cellular telephone, watch, wallet, PDA, and laptop computer and remind him if anything is missing. FIG. 5D shows a setup form completed by a user named Alice. As can be seen from boxes 532 and 534, Alice has RFID tags on all of her belts. She has completed this setup form to remind her to wear a belt on weekdays. She has over seven belts, but needs only one per day. Box 536 contains the number “one” so that wireless communication device 402 is satisfied after finding only one belt.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An identity determining system comprising:
one or more items possessing a plurality of unique wireless identifiers; and
a wireless communication device capable of detecting the items through wireless communication;
wherein the wireless communication device determines identity based on the presence of the wireless identifiers.

2. The system in claim 1, wherein the wireless communication is one of RFID, BLUETOOTH, and WI-FI.

3. The system in claim 1, wherein a user may complete a setup form within the wireless communication device which specifies the one or more items necessary for identification.

4. The system in claim 3, wherein the setup form is stored in a database in communication with the wireless communication device along with a plurality of setup forms for a plurality of other users.

5. The system in claim 1, wherein the identification is used to activate a privilege.

6. The system in claim 5, wherein the privilege is one of unlocking a vehicle, starting a vehicle, unlocking a house, and decrypting a data file.

7. The system in claim 5, wherein the privilege may be not be activated upon detecting fewer items than the user's preference.

8. The system in claim 1, wherein a plurality of items comprises one or more of an article of clothing, equipment, collectable, disposable, consumable, and an animal.

9. A reminder system comprising:
a plurality of items possessing a plurality of unique wireless identifiers;
a wireless communication device capable of detecting the plurality of items through wireless communication;
wherein the wireless communication device is programmed to seek the plurality of items and alert when one or more is not detected.

10. The system in claim 9, wherein the unique wireless identifiers use one or more of BLUETOOTH, WI-FI, and RFID.

11. The system in claim 9, wherein the plurality of items are one or more of an article of clothing, equipment, collectable, disposable, consumable, and an animal.

12. The system in claim 9, wherein the wireless communication is one or more of WI-FI, BLUETOOTH, and RFID.

13. The system in claim 9, wherein a user may complete a setup form within the wireless communication device which specifies the plurality of items of which the user wishes to be reminded.

14. The system in claim 13, wherein the user may also specify a time or event when the user wishes to be reminded.

15. The system in claim 13, wherein the setup form is stored in a database in communication with the wireless communication device along with a plurality of setup forms for a plurality of other users.

16. The system in claim 9, wherein the alert is one of an audible and/or visual alert.

17. The system in claim 16, wherein the audible alert is a voice that speaks to the user.

18. The system in claim 9, wherein a detector alerts the user when each of the plurality of items is found.

19. A method of identification comprising the steps of:
seeking a plurality of items having unique wireless identifiers through wireless communication;
detecting through wireless communication more than one item within a detectable range;
activating a privilege upon finding the plurality of items;
wherein the identity is determined based on detecting the plurality of unique identifiers.

20. The method in claim 19, wherein the seeking step is initiated by a user set event.
